(19) United States
(12) Patent Application Publication
(10) Pub. No.: US 2010/0097544 A1
(43) Pub. Date: Apr. 22, 2010

(54) Light emission device with spacer mounting regions and display device using the same

(76) Inventors: Kyu-Won Jung, Yongin-si (KR); Hun-Soo Kim, Yongin-si (KR); Bon-Gak Gu, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/810,091

(22) Filed: Jun. 1, 2007

(30) Foreign Application Priority Data
Nov. 15, 2006 (KR) 10-2006-0112928

(51) Int. Cl. G02F 1/13357; H01J 19/42; G09F 13/08

(52) U.S. Cl. 349/71; 313/292; 362/97.1

(57) ABSTRACT

According to an embodiment, a light emission device and a display device having the light emission device as a light source are provided. The light emission device includes a first substrate; a second substrate opposing the first substrate; a gate electrode formed over the first substrate; a plurality of electron emission areas on the gate electrode, each electron emission area comprising a plurality of openings formed through the gate electrode, wherein electrons are to be emitted from the electron emission areas through the plurality of openings in a general direction from the first substrate to the second substrate; a light emission unit located on the second surface facing the first substrate; and at least one spacer interposed between the first and second substrates, wherein the gate electrode comprises a plurality of spacer mounting regions, each of which is free of openings and is immediately next to each electron emission area, and wherein each of the plurality of electron emission areas have a generally identical shape when viewed from the second substrate in a direction perpendicular to the gate electrode.

### CROSS-REFERENCE TO RELATED APPLICATIONS

This application claims priority to and the benefit of Korean Patent Application No. 10-2006-0112928 filed on Nov. 15, 2006, in the Korean Intellectual Property Office, the disclosure of which is incorporated herein by reference in its entirety.

### BACKGROUND OF THE INVENTION

1. Field

The present disclosure relates to a light emission device and a display device, and more particularly, to a light emission device that is designed to improve a light emission uniformity of an active area and a display device using the light emission device as a light source.

2. Description of the Related Technology

Light emission devices that can emit light to an external side typically have a first substrate on which electron emission regions and driving electrodes are provided and a second substrate on which a phosphor layer and an anode electrode are provided. The light emission device emits visible light by exciting the phosphor layer using electrons emitted from the electron emission regions.

A sealing member is typically provided between peripheries of the first and second substrates to seal them together and thus form a vacuum vessel. The interior of the vacuum vessel is exhausted to maintain a vacuum level of about 10⁻⁶ Torr. A plurality of spacers are arranged between the first and second substrates to withstand compression force applied to the vacuum vessel.

The light emission device may be used as a light source for a display device having a passive type display panel, such as a liquid crystal display panel. When the light emission device is used as the light source for a display device, some important optical properties include: (a) high luminance with relatively lower power consumption, (b) light emission with uniform intensity throughout an active area, and (c) improved display quality (e.g., contrast ratio) of an image realized by the display device. An improved light emission device including these properties is desired.

### SUMMARY OF THE INVENTION

Exemplary embodiments in accordance with the present invention provide a light emission device that is designed to improve a light emission uniformity of an active area by minimizing a luminance variation around a spacer and improve a contrast ratio of an image, and a display device using the light emission device as a light source.

According to an embodiment, a light emission device includes a field emission device. The light emission device comprises a first substrate; a second substrate opposing the first substrate; a gate electrode formed over the first substrate; a plurality of electron emission areas on the gate electrode, each electron emission area comprising a plurality of openings formed through the gate electrode, wherein electrons are to be emitted from the electron emission areas through the plurality of openings in a general direction from the first substrate to the second substrate; and a spacer interposed between the first and second substrates, wherein the gate electrode comprises a plurality of spacer mounting regions, each of which is free of openings and is immediately next to each electron emission area, and wherein each of the plurality of electron emission areas have a generally identical shape when viewed from the second substrate in a direction perpendicular to the gate electrode.

According to an embodiment, a display device comprises a display panel for displaying an image; and a light emission device with a field emission device emitting light toward the display panel. The light emission device includes a first substrate; a second substrates opposing the first substrate; a gate electrode formed over the first substrate; a plurality of electron emission areas on the gate electrode, each electron emission area comprising a plurality of openings formed through the gate electrode, wherein electrons are to be emitted from the electron emission areas through the plurality of openings in a general direction from the first substrate to the second substrate; a light emission unit located on the second surface facing the first substrate; and at least one spacer interposed between the first and second substrates, wherein the gate electrode comprises a plurality of spacer mounting regions, each of which is free of openings and is immediately next to each electron emission area, and wherein each of the plurality of electron emission areas have a generally identical shape when viewed from the second substrate in a direction perpendicular to the gate electrode.

### BRIEF DESCRIPTION OF THE DRAWINGS

A more complete appreciation of the present invention and many of the attendant features and advantages thereof, will be readily apparent as the present invention becomes better understood by reference to the following detailed description when considered in conjunction with the accompanying drawings in which like reference symbols indicate like components, wherein:

FIG. 1 is a partially exploded perspective view of a light emission device according to an exemplary embodiment of the present invention;

FIG. 2 is a partial sectional view of the light emission device of FIG. 1;

FIG. 3 is a partial plane view of a light emission unit of the light emission device of FIGS. 1 and 2; and

FIG. 4 is an exploded perspective view of a display device according to an exemplary embodiment of the present invention.

### DETAILED DESCRIPTION OF EMBODIMENTS

In a light emission device, the electron emission regions cannot be positioned in areas where the spacers are located. In addition, in order to suppress surface charge in the spacers, which is caused by collision of electron beams with the spacers, there should be a sufficient distance between the spacer and the electron emission regions. If the surface of the spacer is charged with electricity, an electron beam path can get distorted around the spacer. As a result, an excessively large or small amount of light can be emitted from the phosphor layer around the spacer. That is, light emission uniformity can get deteriorated around the spacer.

One solution to this problem is to suppress electric charge in the spacer by reducing the number of the electron emission regions around the spacer. However, this approach inevitably decreases the luminance around the spacer, thus deteriorating light emission uniformity.

Embodiments of the invention will now be described more fully with reference to the accompanying drawings, in which exemplary embodiments are shown. Embodiments may, however, be in many different forms and should not be construed as being limited to the embodiments set forth herein. Rather, these embodiments are provided so that this disclosure is thorough and complete, and will fully convey the concept of embodiments of the invention to those skilled in the art.

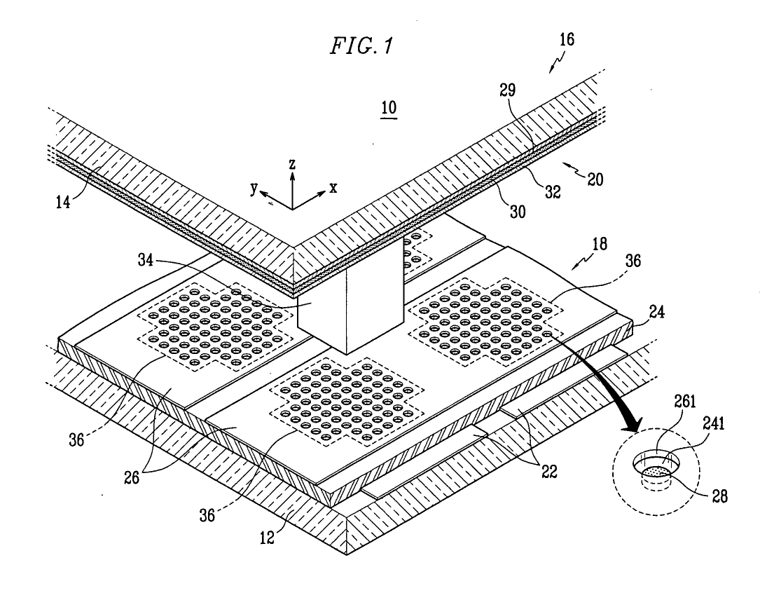

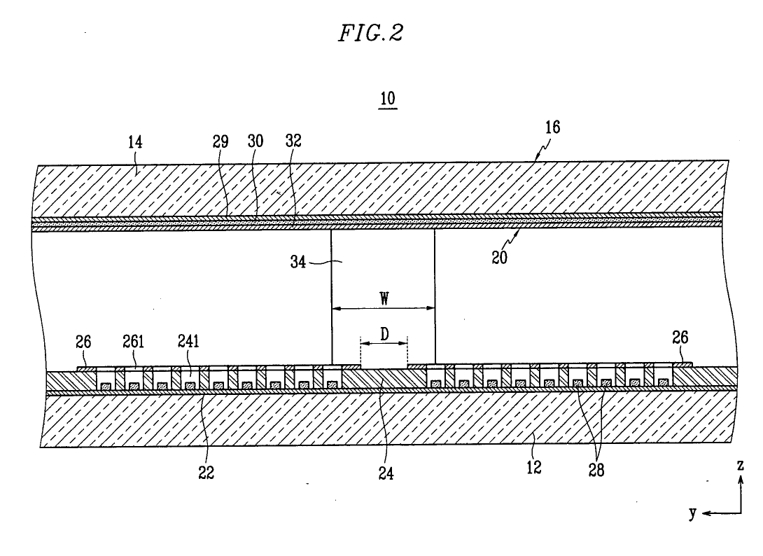

Referring to FIGS. 1 and 2, a light emission device 10 includes a vacuum vessel 16 having first and second substrates 12 and 14 facing each other in a parallel manner at a predetermined interval. A sealing member (not shown) is provided between peripheries of the first and second substrates 12 and 14 to seal them together and thus form the vacuum vessel 16. The interior of the vacuum vessel 16 is exhausted during the manufacturing process of the light emission device 10, thereby being maintaining the vacuum at a level of about 10⁻⁶ Torr.

Within the sealing member, the first and second substrates 12 and 14 may be divided into an active area emitting visible light and inactive area surrounding the active area. An electron emission unit 18 may be provided on the active area of the first substrate 12 and a light emission unit 20 for emitting visible light may be provided on the active area of the second substrate 14.

The electron emission unit 18 can include first and second electrodes 22 and 26 that are arranged in stripe patterns intersecting each other with an insulation layer 24 and electron emission regions 28 electrically connected to the first electrodes 22 or the second electrodes 26 interposed therebetween.

When electron emission regions 28 are formed on the first electrodes 22, the first electrodes 22 become cathode electrodes applying a current to the electron emission regions 28 and the second electrodes 26 become gate electrodes for inducing the electron emission by forming an electric field using the voltage difference from the cathode electrodes. On the contrary, when the electron emission regions 28 are formed on the second electrodes 26, the second electrodes 26 become the cathode electrodes and the first electrodes 22 become the gate electrodes.

Among the first and second electrodes 22 and 26, electrodes (e.g., second electrodes 26) extending in a ‘row’ direction, such as the x-axis in FIG. 1, of the light emission device 10 can function mainly as scan electrodes applied with a scan driving voltage, and electrodes (e.g., first electrodes 22) extending in a ‘column’ direction, such as the y-axis in FIG. 1, of the light emission device 10 can function as data electrodes applied with a data driving voltage.

In one embodiment, openings 261 and openings 241 are formed respectively in the second electrodes 26 and the insulation layer 24 at regions where the first and second electrodes 22 and 26 intersect each other, and partly expose the surface of the first electrodes 22. Electron emission regions 28 are located on the first electrodes 22 in the openings 241 of the insulation layer 24. However, embodiments of the invention are not limited to this particular embodiment.

The electron emission regions 28 are formed of a material emitting electrons when an electric field is formed around thereof under a vacuum atmosphere, such as a carbon-based material or a nanometer-sized material. For example, the electron emission regions 28 may includes at least one of the materials selected from the group consisting of carbon nanotubes, graphite, graphite nanofibers, diamonds, diamond-like carbon, fullerene C₆₀, silicon nanowires, and a combination thereof.

Alternatively, the electron emission regions may be formed in a tip structure made, for example, of a molybdenum-based material or a silicon-based material.

In the above-described structure, each of the regions where the first electrodes 22 intersect the second electrodes 26 corresponds to a single pixel area of the light emission device 10. Alternatively, two or more of the intersecting regions may correspond to a single pixel area. In the latter case, two or more of the first electrodes 22 and/or two or more of the second electrodes 26, which correspond to the single pixel area, can be electrically connected to each other to receive a common driving voltage.

The light emission unit 20 includes an anode electrode 29, a phosphor layer 30 located on a surface of the anode electrode 29, and a reflection layer 32 covering the phosphor layer 30. The anode electrode 29 is an acceleration electrode that receives a high voltage to place the phosphor layer 30 at a high electric potential state. The anode electrode 29 is formed by a transparent conductive material, such as ITO (indium tin oxide).

The phosphor layer 30 may be formed of a mixture of red, green, and blue phosphors to emit white light. The phosphor layer 30 may be formed on an entire active area of the second substrate 14 or in a predetermined pattern having a plurality of sections corresponding to pixel areas. Alternatively, the phosphor layer may include red, green, and blue phosphor layers that are formed in each pixel area and with a predetermined pattern.

In FIGS. 1 and 2, a case where the phosphor layer 30 emitting the white light is formed on the entire active area of the second substrate 14 is illustrated as an example.

The reflection layer 32 may be an aluminum layer having a thickness of about several thousands of angstroms (□) and a plurality of tiny holes for passing the electrons. The reflection layer 32 may function to enhance the screen luminance by reflecting the visible light, which is emitted from the phosphor layer 30 to the first substrate 12, toward the second substrate 14. The anode electrode 29 formed by the transparent conductive material can be eliminated, and the reflection layer 32 can function as the anode electrode.

Disposed between the first and second substrates 12 and 14 are spacers 34 that are able to withstand compressive forces applied to the vacuum vessel 16 and to uniformly maintain a gap between the first and second substrates 12 and 14. Each of the spacers 34 is located at a portion where a space between adjacent first electrodes 22 and a space between adjacent second electrodes 26 intersect each other, i.e., at a diagonal corner of each pixel area.

The spacers 34 can be spaced apart from each other along a direction of the length of the second electrodes 26 (i.e., the x-axis in FIG. 1), and a direction of the width of the second electrodes 26 (i.e., the y-axis in FIG. 1). Two or more of the pixel areas may be located between adjacent spacers 34. In FIG. 1, only one rectangular pillar type spacer 34 and four pixel areas around the spacer 34 according to an embodiment are illustrated.

In the light emission device 10, the plurality of pixel areas are formed by the combination of the first and second electrodes 22 and 26 that are driving electrodes. The light emission device 10 is driven by applying predetermined driving voltages to the first and second electrodes 22 and 26, and by applying a positive direct current voltage (anode voltage) of thousands of volts or more to the anode electrode 29.

Electric fields can be formed around the electron emission regions 28 at the pixels where the difference in voltage between the first and second electrodes 22 and 26 is equal to or greater than a threshold value, and electrons are thus emitted from the electron emission regions 28. The emitted electrons can collide with a corresponding portion of the phosphor layer 30 of the relevant pixels by being attracted by the high voltage applied to the anode electrode 29, thereby exciting the phosphor layer 30. The luminance of the phosphor layer 30 for each pixel corresponds to the amount of electron emission for the relevant pixel.

In the foregoing exemplary embodiment, the first and second substrates 12 and 14 are spaced apart from each other by a relatively large distance of, e.g. about 5-20 mm. By increasing the distance between the substrates 12 and 14, the arcing generation in the vacuum vessel 16 can be reduced. The anode electrode 29 may be applied with a voltage of 10 kV or more, preferably 10-15 kV.

The spacer 34 is designed to have a height corresponding to the distance between the first and second substrates 12 and 14, and a width (W of FIG. 2) greater than a distance (D of FIG. 2) between the adjacent second electrodes 26. Therefore, the spacer 34 is formed over adjacent second electrodes 26.

The above-described light emission device 10 can realize a luminance of 10,000 cd/m² at a central portion of the active area. That is, the light emission device 10 can realize a higher luminance with a lower electric power consumption compared with a conventional cold cathode fluorescent lamp (CCFL) type of light emission device and a conventional light emitting diode (LED) type of light emission device.

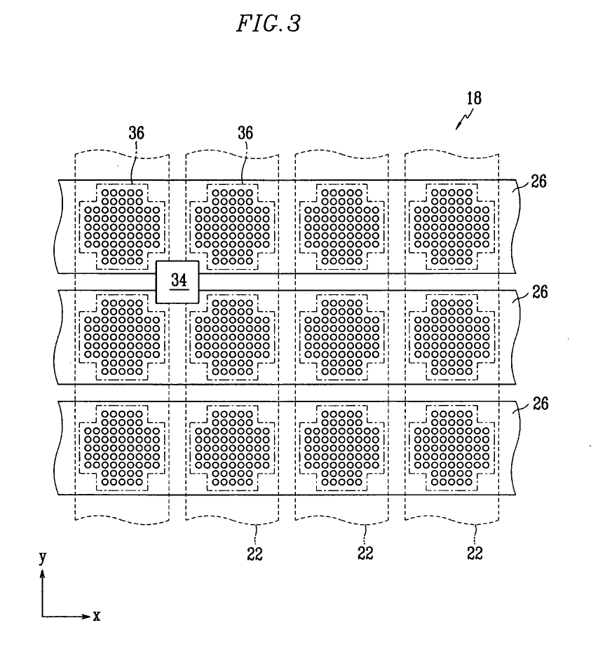

FIG. 3 is a partial top plane view of the electron emission unit of a light emission device according to an embodiment.

Referring to FIGS. 1 through 3, portions within the pixel areas where the electron emission is actually realized by the electron emission regions 28 are referred to as electron emission areas, and all of the pixel areas of the light emission device 10 have electron emission areas 36 that are identical in shape to each other regardless of whether the spacer 34 is adjacent thereto. FIGS. 1 and 3 illustrate an example of where one of the intersecting regions between the first and second electrodes 22 and 26 corresponds to a single pixel area.

The shape of the electron emission areas 36 is designed in consideration of the installation of the spacer 34. That is, each of the electron emission areas 36 may be formed in a rectangular shape corresponding to the rectangular pixel area, except that its four corners may be eliminated. That is, the electron emission regions 28 are not provided on the four corners of the rectangular pixel area. Therefore, the electron emission area 36 is generally formed in a cross shape according to an embodiment as shown in FIGS. 1 and 3.

In addition, the electron emission regions 28 may be formed with a substantially identical shape in each electron emission area 36, and spaced apart from each other by a predetermined and substantially equal distance in the length and width directions of the second electrode 26 so that the amount of electrons that are emitted from the pixels when an identical driving voltage is applied can be the same for each electron emission region 28.

In the light emission device 10 according to the illustrated embodiment, since all of the pixel areas are substantially identical to each other in the number and pattern of the electron emission regions 28, regardless of the installation of the spacers 34, the amount of electrons emitted from the pixel areas can become identical to each other and thereby improve the light emission uniformity of the active area.

Furthermore, since the light emission device 10 of the illustrated embodiment provides a spacer mounting region for all of the pixel areas, the location of the spacers 34 can be freely selected without adjusting the design or pattern of the electron emission regions 28 in specific places for accommodating spacer installation and providing specific spacer mounting regions.

In FIGS. 1 and 3, the cross shaped electron emission areas 36 for the rectangular pillar type spacer 34 are illustrated. However, embodiments of the present invention are not limited to this configuration as shown. That is, the electron emission areas 36 may be formed in a variety of shapes depending on the shape of spacers 34.

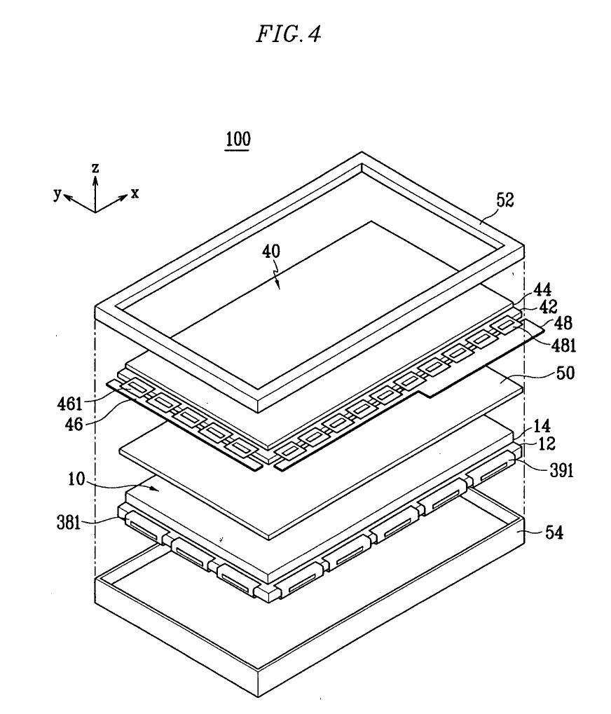

FIG. 4 is an exploded perspective view of a display device using the above described light emission device of FIGS. 1 through 3 as a light source according to an exemplary embodiment. A display device illustrated in FIG. 4 is only provided as an example, and is not intended to limit the present embodiments of the invention.

Referring to FIG. 4, a display device 100 includes a light emission device 10 and a display panel 40 located in front of the light emission device 10. A diffuser 50 for uniformly diffusing light emitted from the light emission device 10 to the display panel 40 may be located between the light emission device 10 and the display panel 40. The diffuser 50 may be spaced apart from the light emission device 10 by a predetermined distance. A top chassis 52 may be located in front of the display panel 40 and a bottom chassis 54 may be located behind the light emission device 10.

A liquid crystal display panel or other light receiving type (not-emissive type) display panels may be used as the display panel 40 according to other embodiments. In the following description, a case where the display panel 40 is a liquid crystal display panel will be explained as an example, and is not intended to limit embodiments of the invention.

The display panel 40 may include a lower substrate 42 having a plurality of thin film transistors ('TFT's), an upper substrate 44 located above the lower substrate 42, and a liquid crystal layer (not shown) formed between the substrates 42 and 44. Polarizing plates (not shown) may be attached on a top surface of the upper substrate 44 and a bottom surface of the lower substrate 42 to polarize the light passing through the display panel 40.

Each of the TFT's can have a source terminal connected to data lines, a gate terminal connected to gate lines, and a drain terminal connected to a pixel electrode formed by a transparent conductive material. When an electric signal is input from circuit board assemblies 46 and 48 to the respective gate and data lines, the electric signal is input to the gate and source terminals of the TFT. The TFT can be turned on or off in accordance with the electric signal to output an electric signal required for driving the pixel electrode to the drain terminal.

The upper substrate 44 may include RGB color filters and a common electrode formed by a transparent conductive material. When the TFT is turned on by applying an electric signal to the gate and source terminals, an electric field may be formed between the pixel electrode and the common electrode. A twisting angle of liquid crystal molecular is varied, in accordance of which the light transmittance of the corresponding pixel is varied.

The circuit board assemblies 46 and 48 of the display panel 40 are respectively connected to driving IC packages 461 and 481. In order to drive the display panel 40, the gate circuit board assembly 46 transmits a gate driving signal and the data circuit board assembly 48 transmits a data driving signal.

The light emission device 10 may include a plurality of pixels, the number of which may be less than the number of pixels of the display panel 40 so that one pixel of the light emission device 10 can correspond to two or more of the pixels of the display panel 40. Each pixel of the light emission device 10 can emit the light in response to the highest gray level among gray levels of the corresponding pixels of the display panel 40. The light emission device 10 can represent a 2-8 bit gray at each pixel.

For convenience, the pixels of the display panel 40 are referred as first pixels and the pixels of the light emission device 10 are referred as second pixels. The first pixels corresponding to one of the second pixels is referred as a first pixel group.

Describing a driving process of the light emission device 10, a signal control unit (not shown) controlling the display panel 40 may detect the highest gray level of the first pixel group, operate a gray level required for emitting light from the second pixel in response to the detected high gray level, convert the operated gray level into digital data, and generate a driving signal of the light emission device 10 using the digital data. The driving signal of the light emission device 10 can include a driving signal and a data driving signal.

Scan and data circuit board assemblies (not shown) of the light emission device 10 may be respectively connected to driving IC packages 381 and 391. In order to drive the light emission device 10, the scan circuit board assembly can transmit a scan driving signal and the data circuit board assembly can transmit a data driving signal.

When an image is displayed on the first pixel group, the corresponding second pixel of the light emission device 10 can emit light with a predetermined gray level by synchronizing with the first pixel group. As described above, the light emission device 10 may control independently a luminance of each pixel and thus provide the proper intensity of light to the corresponding pixels of the display panel 40. As a result, the display 100 of the present exemplary embodiment can enhance the contrast ratio of the screen, thereby improving the display quality.

Although exemplary embodiments have been described in detail hereinabove, it should be clearly understood that many variations and/or modifications of the basic inventive concept taught herein still fall within the spirit and scope of the present invention, as defined by the appended claims and their equivalents.

What is claimed is:

1. A light emission device with a field emission device, the light emission device comprising:
a first substrate;
a second substrate opposing the first substrate;
a gate electrode formed over the first substrate;
a plurality of electron emission areas on the gate electrode, each electron emission area comprising a plurality of openings formed through the gate electrode, wherein electrons are to be emitted from the electron emission areas through the plurality of openings in a general direction from the first substrate to the second substrate; and
at least one spacer interposed between the first and second substrates,
wherein the gate electrode comprises a plurality of spacer mounting regions, each of which is free of openings and is immediately next to each electron emission area, and
wherein each of the plurality of electron emission areas has a generally identical shape when viewed from the second substrate in a direction perpendicular to the gate electrode.

2. The light emission device of claim 1, wherein a spacer is located on each of the spacer mounting regions.

3. The light emission device of claim 1, wherein a spacer is located only on some of the spacer mounting regions, and wherein the remaining spacer mounting regions do not have a spacer thereon.

4. The light emission device of claim 1, wherein two or more spacer mounting regions next to neighboring electron emission areas in combination form a space for mounting the spacer.

5. The light emission device of claim 1, wherein the gate electrode extends in a first direction, wherein the device further comprises a cathode electrode extending in a second direction and an insulating layer interposed between the gate and cathode electrodes, wherein the gate electrode and the cathode electrode intersect with each other when viewed from the second substrate, and wherein the electron emission areas are located in an area where the gate and cathode electrodes intersect with each other.

6. The light emission device of claim 1, further comprising an additional gate electrode neighboring the gate electrode, wherein the spacer is located on adjacent edges of the gate electrodes.

7. The light emission device of claim 1, wherein each electron emission area has a generally rectangular shape whose four corners are eliminated.

8. The light emission device of claim 1, wherein each electron emission area has a generally cross shape.

9. The light emission device of claim 1, wherein each electron emission area has the same number of openings through which electrons are to be emitted.

10. The light emission device of claim 9, wherein the openings at each electron emission area are spaced apart from each other by a substantially equal distance.

11. A display device comprising:
a display panel for displaying an image; and
a light emission device with a field emission device emitting light toward the display panel, wherein the light emission device includes:
a first substrate;
a second substrates opposing the first substrate;
a gate electrode formed over the first substrate;
a plurality of electron emission areas on the gate electrode, each electron emission area comprising a plurality of openings formed through the gate electrode, wherein electrons are to be emitted from the electron emission areas through the plurality of openings in a general direction from the first substrate to the second substrate;
a light emission unit located on the second surface facing the first substrate; and
at least one spacer interposed between the first and second substrates, wherein the gate electrode comprises a plurality of spacer mounting regions, each of which is free of openings and is immediately next to each electron emission area, and
wherein each of the plurality of electron emission areas has a generally identical shape when viewed from the second substrate in a direction perpendicular to the gate electrode.

12. The display device of claim 11, wherein a spacer is located on each of the spacer mounting regions.

13. The display device of claim 11, wherein a spacer is located only on some of the spacer mounting regions, and wherein the rest of the spacer mounting regions do not have a spacer located thereon.

14. The display device of claim 11, wherein the spacer is a pillar structure.

15. The display device of claim 11, wherein each electron emission area has a generally cross shape.

16. The display device of claim 11, wherein each electron emission area has the same number of openings through which electrons are to be emitted.

17. The display device of claim 16, wherein the openings at each electron emission area are spaced apart from each other by a substantially equal distance.

18. The display device of claim 11, wherein the display panel has a number of first pixels and the light emission device has a number of second pixels, wherein the number of second pixels is less than the number of first pixels and wherein luminance of each second pixel is independently controlled.

19. The display device of claim 11, wherein the display panel is a liquid crystal display panel.
